(19) United States
(12) Patent Application Publication
(10) Pub. No.: US 2008/0293528 A1
(43) Pub. Date: Nov. 27, 2008

(54) Independently rotating bash guard

(76) Inventor: Robert O. Paull, Salt Lake City, UT (US)

Correspondence Address: Floris Chad Copier, 5373 W. 10480 N., Highland, UT, 84003, US

(21) Appl. No.: 12/115,667

(22) Filed: May 6, 2008

Related U.S. Application Data
(60) Provisional application No. 60/939,157, filed on May 21, 2007.

(51) Int. Cl. B62J 13/00; G06F 17/00

(52) U.S. Cl. 474/144; 701/45

(57) ABSTRACT

In cycling activities, riders often encounter rough terrain having various obstacles such as rocks, mounds, tree roots, and branches. These obstacles subject the bicycle's crankset and chain to extremes in stress, loading, and impact. An improved bash guard may be attached to the bicycle to protect against damage. The bash guard may include at least one rotator operatively secured to a crankset or a crank arm on the bicycle. The rotator(s) may be configured to rotate independent of the crankset rotation. The independent rotation of the rotator(s) may permit the bash guard to roll over obstacles, significantly reducing frictional sliding or rubbing between an edge of the bash guard and the obstacles.

### FIELD

This application relates generally to bicycle drive trains. In particular, this application relates to a bash guard for protecting a sprocket and other drive train components from damage from impact with foreign objects.

### BACKGROUND

The sport of cycling has proven to be an extremely popular and long lasting sport and recreational activity. Through the years, a wide range of participants have pursued a variety of cycling or biking activities. Not surprisingly, the various cycling or biking activities and recreations have involved a variety of environmental circumstances ranging from high speed competition to slow and casual pleasure riding or cycling. In recent years a type of cycling has emerged which is generally referred to as off-road biking or mountain biking. In this sport activity, participants often ride over extremely rough terrain and challenging hill and mountain trails. These rough terrains and trails often have various obstacles such as rocks, mounds, tree roots, branches, etc., which subject the bicycle's various components to extremes in stress, loading, and impact.

For example, as shown in FIG. 1, the drive train on bicycle 100 could get damaged by rock 102 as bicycle 100 runs over it or when the bicycle crashes. Particularly prone to damage are the chain 104 and front crankset 106, which includes from one to four or more variously sized sprockets, each including sprocket teeth 108. Front crankset 106 rotates chain 104 by means of sprocket teeth 108 on the outer edges of the sprockets of crankset 106. Teeth 108 are exposed to various obstacles, such as rock 102 or other foreign obstacle that a bicycle may encounter on rough terrain. To meet the need for protecting drive train components against damage in rough terrain environments, practitioners in the art have endeavored to provide guard devices (i.e., bash guards, chain guards) that attach to the bicycle frame, to crankset 106, or to an outer part of crankset 106.

A conventional bash guard is typically a ring made out of a durable material such as aluminum or a polycarbonate and has a width or diameter that is larger than that of the largest sprocket in the crankset. Typically, a conventional bash guard is fixed or mounted to the bicycle with bolts and nuts or other common fasteners. A conventional sprocket-mounted bash guard is mounted to the sprockets or an outer part of the sprockets and will rotate in synchronization with the sprockets as the rider pedals. Thus, conventional sprocket-mounted bash guards can operate much like a skid plate for the bicycle. For example, the outer edge of a conventional sprocket-mounted bash guard can limit impact damage to sprockets and other components by allowing the surface of the bash guard to contact an obstacle and slide over the obstacle as the bicycle moves past the obstacle. A conventional bash guard could instead be mounted to the bicycle's frame. In this frame-mounted configuration, the bash guard remains stationary with respect to the bicycle frame and does not rotate with the rotation of the bicycle pedals.

Because of their fixed nature, conventional bash guards (both sprocket-mounted and frame-mounted) often rub or slide against obstacles and, therefore, require replacement to maintain their function or appearance. Additionally, a bicycle rider may hang up on an obstacle, causing a crash, or requiring the rider to push or attempt to pedal the bicycle over the obstacle. Frame-mounted bash guards are particularly susceptible to being worn down by friction, and impact on the same point. Sprocket-mounted bash guards are also susceptible because they frequently slip or rub on hard obstacles, such as rocks or dense branches. Furthermore, when a sprocket-mounted bash guard slips laterally, even slightly, over an obstacle, this will cause the bicycle to become unstable and may cause the rider to fall and incur potentially serious injuries.

One way to address the problem of frequent replacement is to form the bash guard out of an extremely durable material. However, this solution is undesirable because higher durability comes at a cost, and weight penalty. What is needed is a bash guard that resists wear and aids the rider in overcoming obstacles. The present invention remedies one or more of the problems discussed above with respect to conventional bash guards.

### BRIEF DESCRIPTION OF THE DRAWINGS

The following description can be better understood in light of Figures, in which:

FIG. 1 is a representation of prior art of a bicycle damaged by a rock;

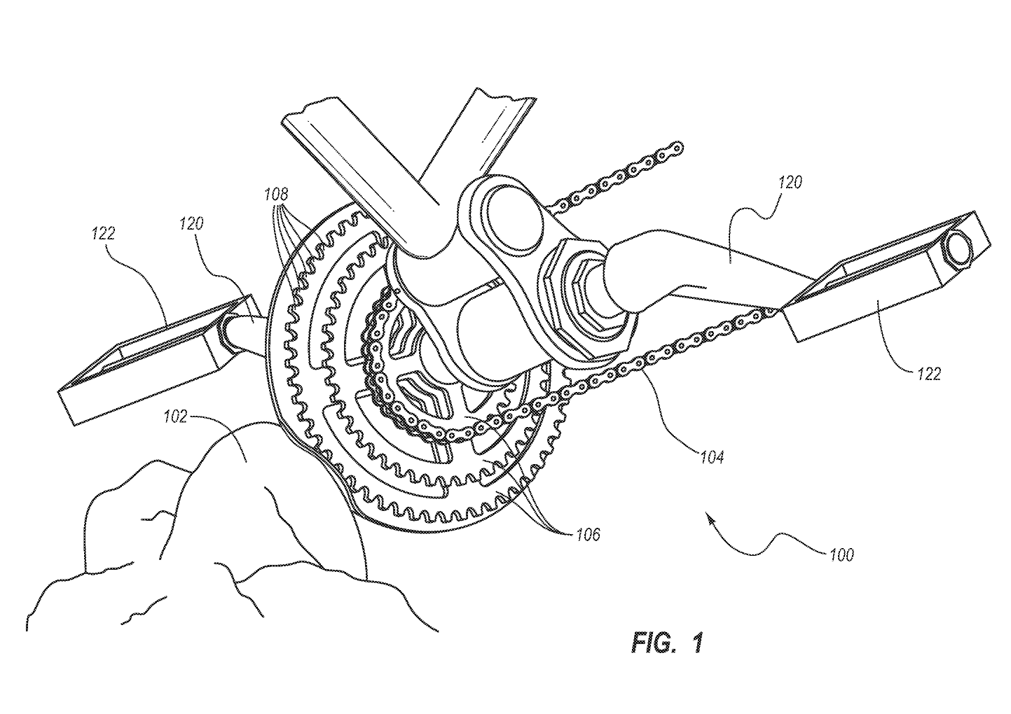

FIG. 2 illustrates a bicycle with an embodiment of a rotating bash guard in place;

FIGS. 3A-3C illustrate different view of an exemplary embodiment of a rotating bash guard;

FIGS. 4A-4B illustrates a component of an exemplary embodiment of a bash guard; and

FIG. 5 illustrates an exemplary embodiment of a rotating bash guard; Together with the following description, the Figures demonstrate and explain the principles of exemplary bash guards. In the Figures, the thickness and configuration of components may be exaggerated for clarity. The same reference numerals in different Figures represent the same component.

### DETAILED DESCRIPTION

An improved bash guard may be configured to rotate independently, or contain components that rotate independently of the rotation of a cycling device's crankset, causing the bash guard to roll over obstacles encountered on a rough terrain. Rolling over obstacles significantly reduces frictional sliding or rubbing between an edge of the bash guard and the obstacles. Various embodiments of an improved bash guard are described in detail below.

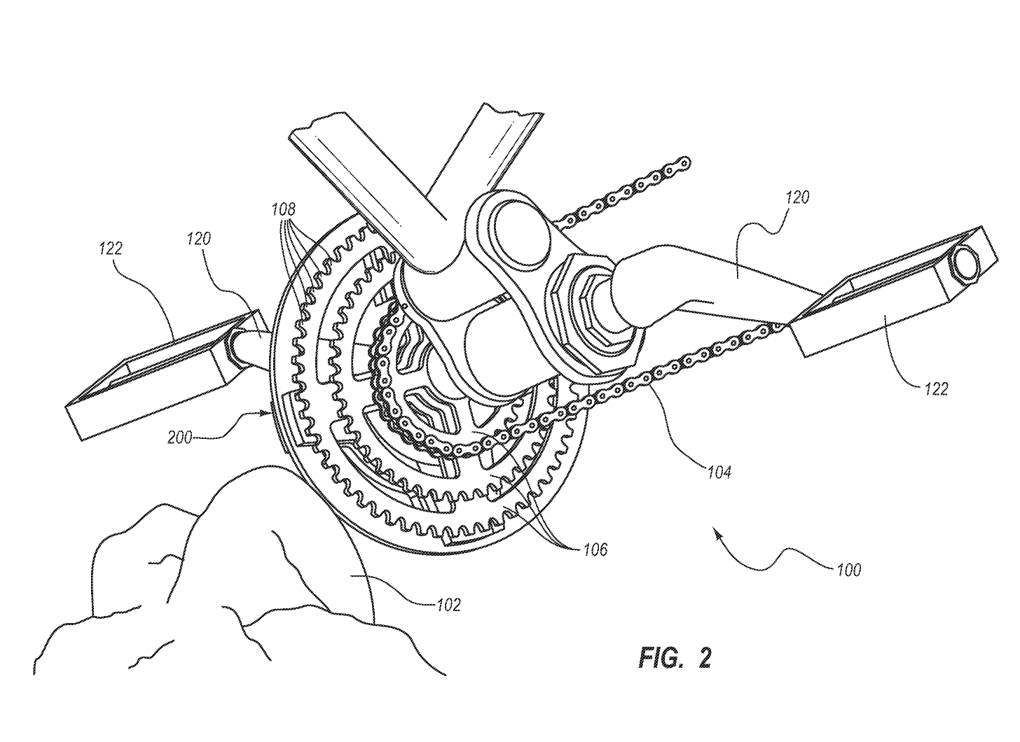

FIGS. 2-4 illustrate some embodiments of guard 200 for mounting on cycling device 100 (e.g., a conventional bicycle, mountain bicycle, touring bicycle, racing bicycle, cruiser bicycle, street bicycle, motorcycle, moped, recumbent bicycle, tricycle, or any combination thereof, or any device with a crankset that may be exposed to damage). Bash guard 200 may protect crankset 106 and chain 104 on cycling device 100. As shown in FIG. 2, crankset 106 may include various teeth 108 operable to move chain 104 in a rotational fashion. For example, a set of crank arms 120 may be mounted 180 degrees from each other and may be configured to rotate when torque is applied by a rider to either of pedals 122. Crankset 106 may be operatively secured to crank arms 122 such that the sprockets of crankset 106 rotate with crank arms 120. The sprockets of crackset 106 may be equipped with teeth 108, which may engage with chain 104, thereby transmitting rotational motion from crank arms 120 to provide a motive force to cycling device 100.

Referring again to FIG. 2, bash guard 200 may include a rotator 202 operatively secured to at least one of the sprockets of crankset 106. Alternatively or in addition, rotator 202 may be operatively secured to other components, such as one or both of crank arms 120. Rotator 202 may be positioned along or near an outer edge of crankset 106. A diameter of rotator 202 may be greater than a diameter of the largest sprocket of crackset 106 to thereby prevent obstacles from impacting or damaging the sprockets of crankset 106 and chain 104.

Rotator 202 may be configured to rotate independent of the rotation of the sprockets and crank arms 120. For example, when a rider pedals, turning crank arms 120 and the sprockets of crankset 106, rotator 202 may rotate independently of crank arm 120 and sprocket rotation. If, for example, the rider goes over an obstacle that makes contact with rotator 202, crank arms 120 and the sprockets may continue rotating in one direction while rotator 202 may rotate in an opposite direction, or may remain stationary with respect to the obstacle while crankset 106 passes over the obstacle. Similarly, crank arms 120 and crankset 106 may remain stationary with respect to bicycle 100 and the rotator 202 may rotate with respect to crankset 106 when contacting an obstacle. For example, a frictional force exerted by the obstacle contacting rotator 202 may cause rotator 202 to begin rotating.

Rotator 202 may be formed with any variety of materials or combination of materials including, for example, metal (e.g., aluminum, steel, and/or titanium), plastic (e.g., polycarbonate), rubber, and others. Furthermore, an outer edge of rotator 202 may have a varied surface (e.g., knurled, grooved, bumpy) so as to increase friction with respect to obstacles encountered on a rough terrain. The varied surface may be designed for particular obstacles, for example, a grooved surface may perform best on wood obstacles to prevent rotator 202 and the sprockets from sliding in a direction normal to the direction of cycling device 100.

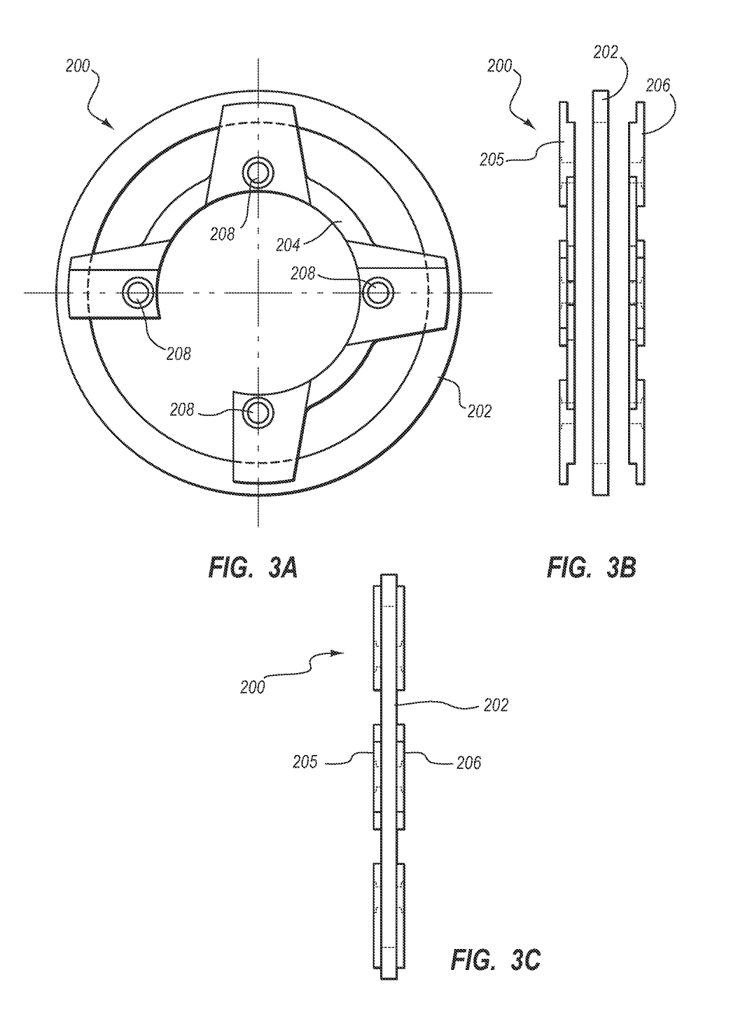

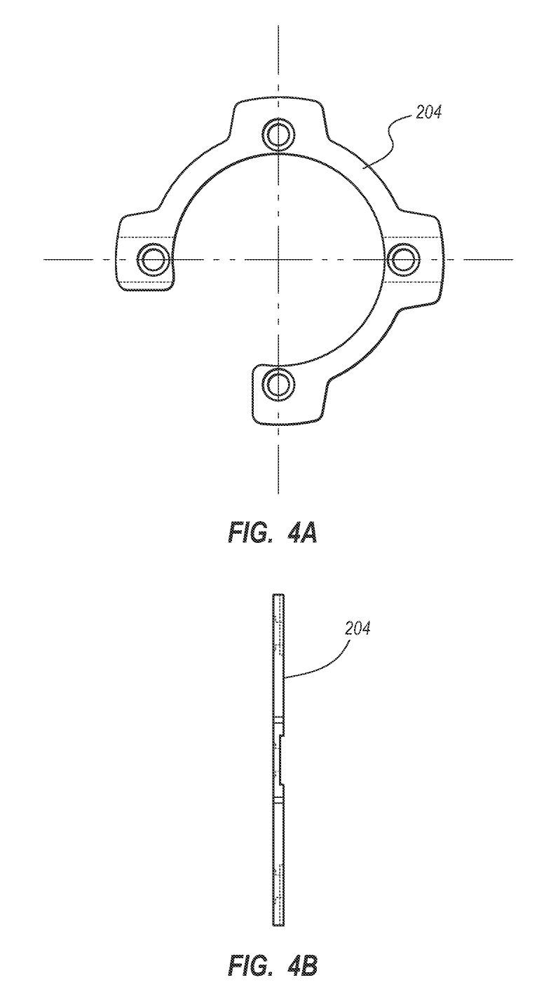

As shown in FIGS. 3A-4B, bash guard 200 may also include a retainer 204 that retains or holds rotator 202 in a particular position with respect to the cycling device. Retainer 204 may be a single integral part or may include a first inner portion 205 and a second outer portion 206. Retainer 204 may also be formed integrally with crankset 106 or any component thereof. Alternatively, retainer 204 may be secured with fasteners (e.g., bolts, nuts, screws, etc.) to one or more of the sprockets in crankset 106, preferably to the largest, outer sprocket. Thus, when a rider applies torque to the crank arms, retainer 204 may rotate in a dependent relationship with respect to the rotation of the sprockets in crankset 106. However, retainer 204 may loosely hold or grasp rotator 202 in a manner that permits rotator 202 to passively rotate independent of the retainer rotation.

Retainer 204 may include bearings, bushings, coatings, or other friction reducing devices that may serve to operatively secure rotator 202 to retainer 204 without preventing rotator 202 from rotating independently of retainer 204 and crackset 106. For example, retainer 204 may include a set of extruding plates arranged in a radial fashion around the edges of each of retainer portions 205 and 206. The plates on first retainer portion 205 may be configured to line up with the plates on second retainer portion 206, thereby forming a plurality of channels around retainer 204 along which rotator 202 may slide without falling off.

The plates of retainer 204 may be configured to lightly squeeze and thereby maintain rotator 202 in a consistent position with respect to retainer 204 such that rotator 202 rotates in phase with retainer 204 and crankset 106 when no obstacles are present. Then, when rotator 202 contacts an obstacle such as rock 102, rotator 202 may slip through the plates of retainer 204 and rotate in an independent fashion. To this end, an inner side of the plates may be lined with Teflon® tape, nylon inserts, or other lubricating elements to facilitate slipping motion with respect to rotator 202. Alternatively, the plates may be manufactured from a material, such as a plastic or other suitable material, that allows rotator 202 to function as described. In other embodiments, bearings may take the place of the plates, or may be incorporated into the plates.

A set of bolt holes 208 may be formed in bottom portions of each of the plates on retainer 204. Rotator 202 may be secured between first and second retainer portions 205 and 206 with bolts threaded through bolt holes 208. Bolt holes 208 may also be aligned with corresponding holes in crankset 106, such that a single set of bolts may secure retainer portions 205 and 206 together while also securing both retainer portions to one or more sprockets in crankset 106. Thus, rotator 202 may be held securely and rotatably with respect to retainer 204.

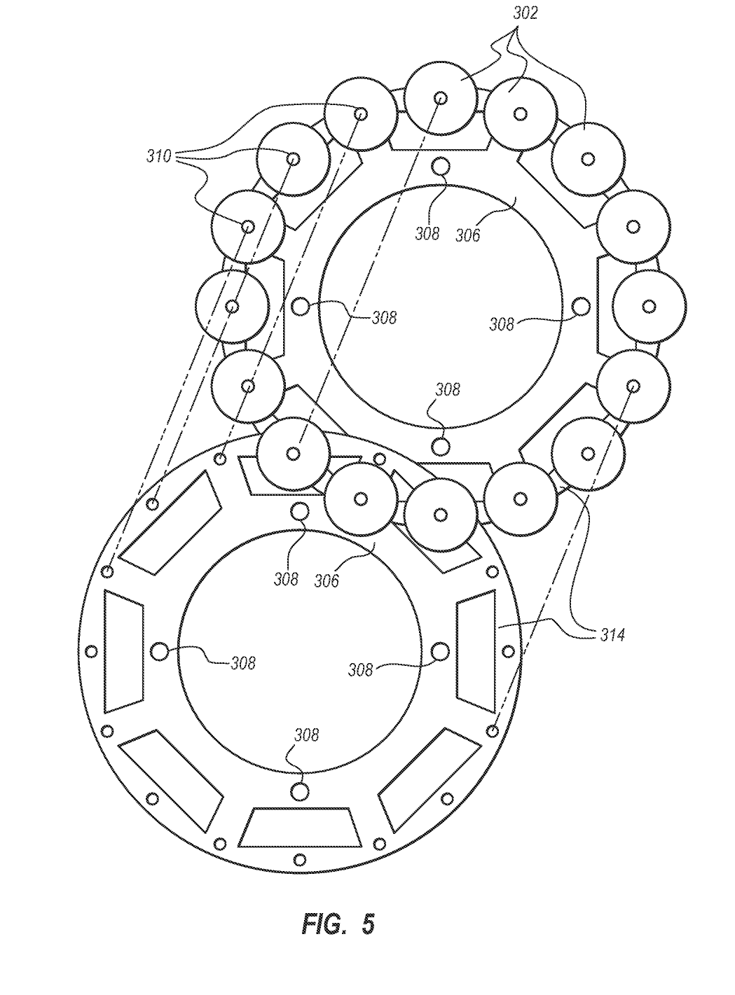

FIG. 5 is a perspective view of another embodiment bash guard 300 for mounting on cycling device 100. Similar to bash guard 200 in FIGS. 2-4B, bash guard 300 may include a retainer 304. Retainer 304 may include mating inner and outer portions 305 and 306 secured together with bolts via a set of bolt holes 308. Retainer 304 may also be configured to secure a plurality of rotators 302 between retainer portions 305 and 306. A plurality of bearings 310 may secure rotators 302 to retainer 304 and each of the plurality of rotators 302 may rotate independent of the rotation of the sprockets and the crank arms of the cycling device. Various additional features may also be present. For example, retainer portions 305, 306 may be detachable (as shown by exemplary dashed lines) to permit replacement or repair of one or more rotators 302, bearings 310, or other components. In addition, rotators 302 may be formed of materials similar to that of rotator 202 in the first embodiment described in FIG. 2. Each of rotators 302 may also have a varied surface on an outer edge similar to rotator 202, e.g., knurled, grooved, bumpy, machined, coated with a slip-resistant coating, etc. to improve grip when passing over obstacles.

In some embodiments, portions of bash guards 200, 300 may be integral with components of the drive train. For example, retainer 204, 304 may be integral with at least one of sprocket 106 or other component of bicycle 100. Similarly, a crankset may be provided with sprockets 106 and bash guard 200 300 in place as a single unit for mounting on bicycle 100. In other embodiments, bash guard 200 300 may vary in size depending on the level of protection desired and on the diameter or the largest sprocket 106 of the crackset. For example, some individuals may want very little size increase of bash guard 200 over the outer diameter of the crackset to allow for maximum clearance during riding, while other individuals may want a larger rotator 202 to more fully protect the drive train. In some embodiments, rotator 202 may be supported by bearings, such as roller bearings or any other type of bearing known to those of ordinary skill.

Other embodiments may include other specific forms without departing from the spirit or essential characteristics of the invention, i.e. the independent movement of a bash ring or bash rings. The described and illustrated embodiments are to be considered in all respects only as illustrative and not restrictive. For example, although some of the Figures include specific dimensions, the invention is not limited to any specific dimensions, and may be any size, thickness, weight, etc. as desired by one of ordinary skill in the art.

Having described the preferred aspects, it is understood that the invention defined by the appended claims is not to be limited by particular details set forth in the above description, as many apparent variations thereof are possible without departing from the spirit or scope thereof.

What is claimed is:

1. A device, comprising:
a crank arm configured to rotate a crankset when torque is applied to the crank arm;
at least one rotator operatively secured to at least one of the crankset or the crank arm,
wherein the at least one rotator are configured to rotate independent of the crankset rotation.

2. The device of claim 1, further comprising:
a retainer operatively secured to at least one of the crankset and the crank arm and configured to rotate in a dependent relationship with respect to the crankset rotation when torque is applied to the crank arm,
wherein the retainer secures the at least one rotator to the retainer without preventing the rotator from rotating independent of the retainer rotation.

3. The device of claim 2, wherein the retaining includes two retainer portions disposed on opposite sides of the at least one rotator.

4. The device of claim 3, wherein the two retainer portions form a channel to secure the at least one rotator to the crankset.

5. The device of claim 4, wherein the retainer is configured such that the channel may be adjusted to supply various amounts of pressure to the at least one rotator, such that amount of force required to move the rotator independently of the retainer may be adjusted.

6. The device of claim 4, wherein the channel includes at least one surface having at least one of a low-friction coating, layer, and finish.

7. The device of claim 2, wherein at least a portion of the retainer is integral with at least one portion of the crankset.

8. The device of claim 1, wherein the at least one rotor is removably secured to at least one of the crankset or the crank arm.

9. The device of claim 1, wherein the at least one rotator comprises a plurality of rotators positioned along an outer edge of the crankset, each rotator having a diameter that is smaller than a diameter of the crankset.

10. The device of claim 1, wherein the at least one rotator comprises a rotator positioned along an outer edge of the crankset, the rotator having a diameter that is greater than a diameter of the crankset.

11. The device of claim 1, wherein the at least one rotator includes an outer edge configured to protect the crankset by engaging obstacles, wherein the outer edge includes a slip-resistant surface feature.

12. The device of claim 11, wherein the slip-resistant surface feature is one of knurling, grooves, teeth, irregular surface extensions, and a coating.

13. A method of protecting a bicycle drivetrain, comprising:
securing a rotator to the drivetrain; and
contacting an obstacle with the rotator such that the rotator rotates independently of the drivetrain.
